(19) United States
(12) Patent Application Publication
(10) Pub. No.: US 2007/0134050 A1
(43) Pub. Date: Jun. 14, 2007

(54) Reversible electric pump and paint roller assembly

(76) Inventors: Daniel J. Bruggeman, Minneapolis, MN (US); Stephen C. Kohs, Forest Lake, MN (US); Dion M. McDevitt, Ramsey, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 11/297,754

(22) Filed: Dec. 8, 2005

(51) Int. Cl. B05C 17/03; A46B 11/02

(52) U.S. Cl. 401/197; 401/188 R

(57) ABSTRACT

A paint roller dispenser apparatus has an electric motor; a pump driven by the motor; a tube connected to the pump for receiving paint; a hose connected to the pump; a handle; a paint roller connected to the hose and to the handle; and a mechanism for reversing the direction of flow of paint between the tube and the roller. In one embodiment, the mechanism is electronic. In other embodiment, the mechanism is mechanical.

### BACKGROUND OF THE INVENTION

The present application relates to a paint dispenser with roller and particularly to a dispenser with a reversible electric pump.

Paint dispensers that pump paint from a can onto a roller exist. Such dispensers typically consist of a pump unit that is placed into the can, a hose connected to the pump unit, a handle, and a paint roller. Paint is pumped from the can, through the hose, the handle, and onto the roller for painting.

However, in order to clean the apparatus after painting, it is necessary to pump any remaining paint that is in the hose and handle through the roller and then scrape the paint off into the can. During this procedure, paint may drip from the roller onto the environment, resulting in wasting paint and contaminating the environment.

There is a need for a paint dispenser with a reversible electric pump that allows paint from the hose and handle to be sucked back into the can without removing the pump unit from the can.

### SUMMARY OF THE INVENTION

A paint roller dispenser apparatus, comprising:

(a) an electric motor;

(b) a pump driven by the motor;

(c) a suction tube connected to the pump and adapted to receive paint;

(d) a hose connected to the pump;

(e) a handle connected to the hose, the handle having a bore for receiving paint from the hose;

(f) a paint roller connected to the handle; and

(g) a mechanism for reversing the direction of flow of paint between the suction tube and the roller, whereby paint can be alternately dispensed onto the roller and removed from the hose and handle.

A principal object and advantage of the present invention is that it permits an electric pump to alternately pump paint from a paint can toward the roller and from the roller back to the paint can.

Another principal object and advantage of the present invention is that it prevents wasting paint and contaminating the environment with paint dripping from the roller and hose.

Another principal object and advantage of the present invention is that it enables easy clean-up of the paint dispenser.

### BRIEF DESCRIPTION OF DRAWINGS

FIG. 1 is a perspective view of a paint dispenser of the prior art.

FIG. 2 is a side elevational view of the dispenser of FIG. 1.

FIG. 3 is a rear elevational view of the dispenser of FIG. 1.

FIG. 4 is a perspective view of a peristaltic pump used with the paint dispenser of FIG. 1.

FIG. 5 is an electrical schematic of a first embodiment of a pump reversing mechanism of the present invention.

FIG. 6A is a schematic of a second embodiment of a pump reversing mechanism of the present invention, showing the mechanism permitting flow from the paint can to the handle of the dispenser.

FIG. 6b is similar to FIG. 6A, but shows the mechanism switched to permit flow from the handle of the dispenser to the paint can.

### DETAILED DESCRIPTION OF THE PREFERRED EMBODIMENT

A typical dispenser of the prior art is available from HomeRight, 1661 94^{th} Lane N.E., Minneapolis, Minn. 55449-4324, as the Electric Power-Flo Roller Painting System.

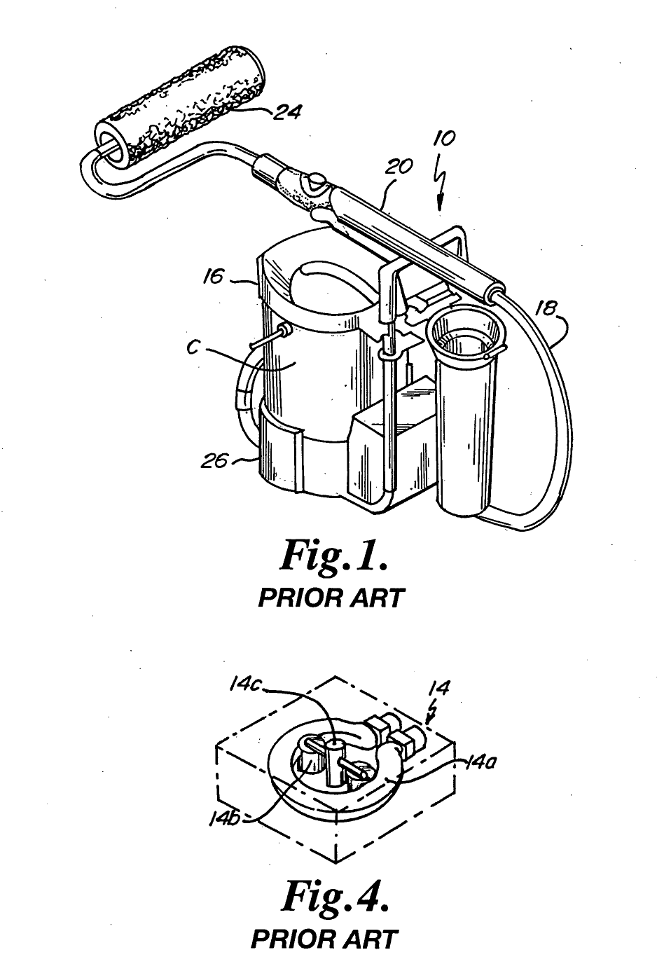

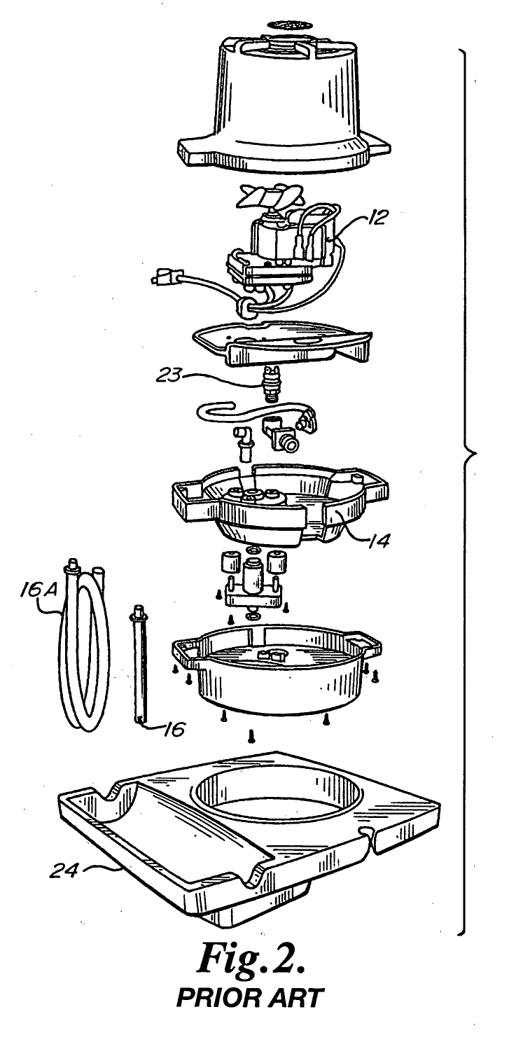

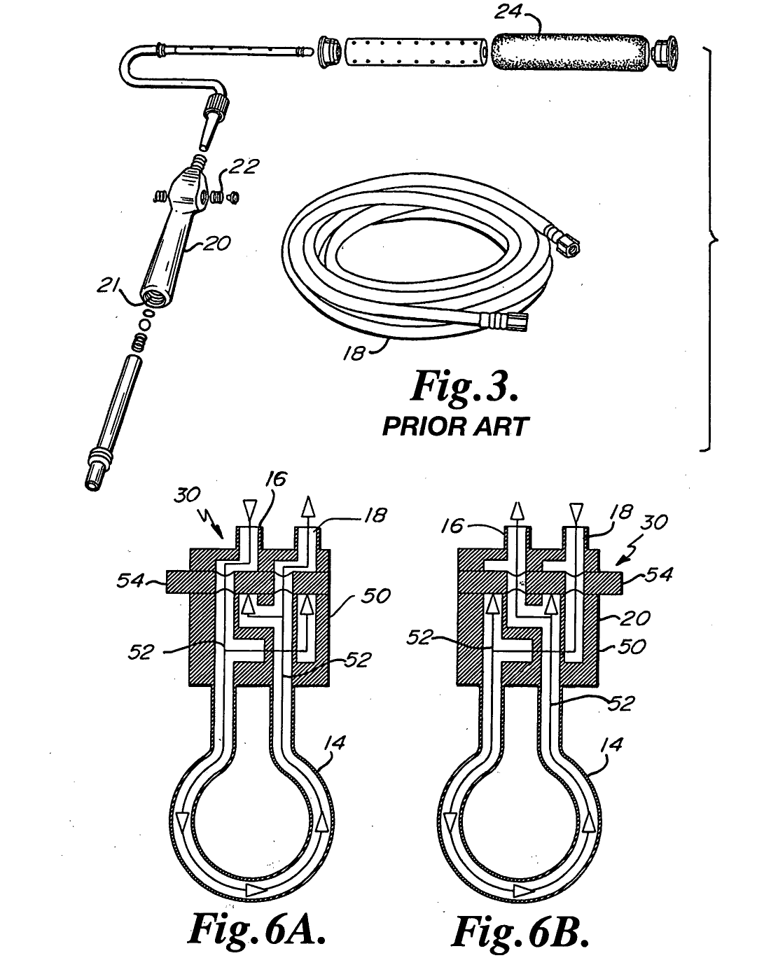

As shown in FIGS. 1-4, the dispenser 10 comprises a motor 12, a pump such as a peristaltic pump 14 driven by the motor 12, suction tube 16 connected to the peristaltic pump 14, hose 18, handle 20 connected to the hose, pressure switch 22, and roller 24.

To set up the apparatus for painting, the roller 24 is connected to the handle 20, which has an internal bore 21 through which paint flows to the roller 24. The hose 18 is suitably connected to the handle 20 and to the peristaltic pump 14. The suction tube 16 is connected to the peristaltic pump 14. The apparatus 10 is then placed onto an open one-gallon paint can C with the suction tube 16 dipping into the paint in the can. Alternatively, a longer suction tube 16A may be placed in the paint can and run to the unit 10 at a nearby location. Electric power is provided to the motor 12, causing paint to be pumped from the paint can C by the peristaltic pump 14 through the suction tube 16, the hose 18, the handle 20, and the roller 24. Paint may then be applied to a surface using the roller 24 in a known manner. Pressing the pressure switch 22 causes a valve 23 to open, dispensing additional paint.

The apparatus 10 may also further comprise a rheostat 26 connected to the motor 12 for adjusting the speed of the motor.

FIG. 4 shows a detail of the peristaltic pump 14. As shown in FIG. 4, the pump 14 comprises a flexible tube 14a, rollers 14b, and drive 14c. The drive 14c is suitably driven by the motor 12. As the drive 14c rotates, the rollers 14b press against the flexible tube 14a to push paint out of the pump 14 to the hose 18.

In order to clean the apparatus, the unit 10 is lifted off the paint can, the suction tube 18 is removed, and any remaining paint in the hose 18 and handle 20 is pumped to the roller 24, where it can be scraped off into the can. Water is then siphoned through the unit 10 using the longer suction tube 16 until water is noticed at the roller 24. The pressure switch 22 is pressed to relieve any pressure in the hose 18. The hose 18 is detached from the pump 14 and the roller 24 is rinsed under water to remove paint.

However, this cleaning process is not ideal because paint from the hose 18 and handle 20 can spatter onto the environment, wasting paint and contaminating the environment.

In order to avoid these problems, the present invention comprises a mechanism 30 for reversing the direction of flow of paint between the suction tube 16 and the roller 24, whereby paint can be alternately dispensed onto the roller 24 and removed from the hose 18 and handle 20.

In one embodiment, the mechanism 30 is electronic.

In this embodiment, the mechanism 30 further preferably comprises a mechanism 32 for reversing the polarity of the motor 12. Preferably, the mechanism 32 for reversing the polarity of the motor 12 further comprises a bias switch 34 normally biasing the polarity of the motor 12 for forward rotation and a relay 36 changing the bias switch 34 thereby biasing the polarity of the motor 12 for reverse rotation. The mechanism 32 also preferably comprises a forward/reverse switch 38 operating on the relay 36. Most preferably, the forward/reverse switch 38 operates on the relay 36 through a transistor 40.

FIG. 5 is an electrical schematic of this embodiment. When the forward/reverse switch 38 is closed, it causes, through pin-out P50 of the chip, a trace voltage of about 5V to be applied to the transistor 40, the transistor 40 being normally open to ground. When the trace voltage is applied to the transistor 40, it closes the transistor 40 to ground. This in turn causes the relay 36 to cause the bias switch 34 to bias the polarity of the motor 12 for reverse rotation. When the switch 38 is opened, the trace voltage is removed from the transistor 40, opening the transistor to ground and in turn causing the relay 36 to cause the bias switch 34 to again bias the polarity of the motor for forward rotation.

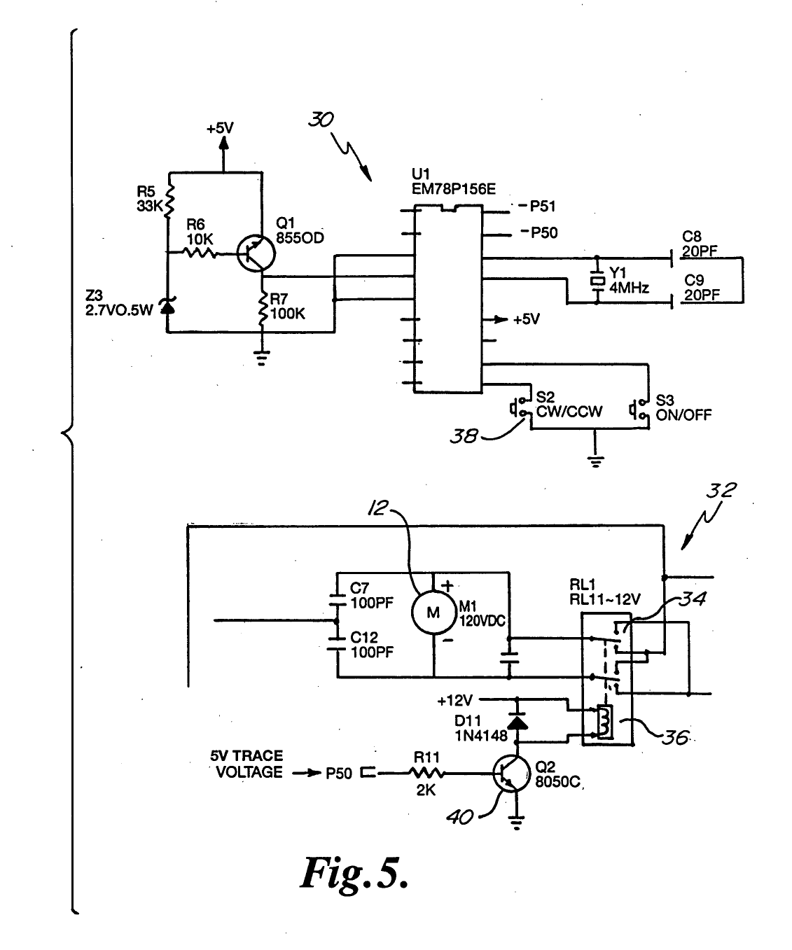

A second embodiment of the mechanism 30 is shown in FIGS. 6A and 6B. In this embodiment, the mechanism 30 is mechanical.

FIG. 6A shows the mechanism 30 set to allow paint to flow from the paint can, through the suction tube 16, the pump 14, and the hose 18 to the roller 24. The mechanism 30 further comprises a two-position valve 50, having a first position (FIG. 6A) permitting paint to flow toward the handle and preventing paint to flow toward the suction tube. FIG. 6B shows the two-position valve 50 in a second position permitting paint to flow toward the suction tube and preventing the flow of paint toward the handle. Various embodiments of the valve 50 are possible. The Figures show an embodiment in which the valve 50 comprises a pair of bores 52 connected to the pump 14 and to the suction tube 16 and hose 18 and a sliding gate 54 which alternately closes off a connection between the bores 52 and either the suction tube 16 or the hose 18.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A paint roller dispenser apparatus, comprising:
(a) an electric motor;
(b) a pump driven by the motor;
(c) a tube connected to the pump for receiving paint;
(d) a hose connected to the pump;
(e) a handle;
(f) a paint roller connected to the hose and to the handle; and
(g) a mechanism for reversing the direction of flow of paint between the tube and the roller.

2. The apparatus of claim 1, wherein the handle has a bore therethrough for carrying paint to the roller.

3. The apparatus of claim 1, wherein the pump is a peristaltic pump.

4. The apparatus of claim 2, wherein the peristaltic pump further comprises a flexible tube, a roller, and a drive, the roller being driven by the drive to press against the flexible tube thereby pushing paint out of the pump.

5. The apparatus of claim 1, wherein the mechanism for reversing the direction of flow of paint is electronic.

6. The apparatus of claim 5, wherein the mechanism for reversing the direction of flow of paint comprises reversing the polarity of the motor.

7. The apparatus of claim 6, wherein the mechanism for reversing the polarity of the motor further comprises a bias switch normally biasing the polarity of the motor for forward rotation and a relay changing the switch bias thereby biasing the polarity of the motor for reverse rotation.

8. The apparatus of claim 7, further comprising a forward/reverse switch operating on the relay.

9. The apparatus of claim 8, wherein the forward/reverse switch acts on the relay through a transistor.

10. The apparatus of claim 1, wherein the mechanism for reversing the direction of flow of paint is mechanical.

11. The apparatus of claim 10, wherein the mechanism for reversing the direction of flow of paint further comprises a two-position valve having a first position permitting the flow of paint toward the handle and preventing the flow of paint toward the suction tube, and a second position permitting the flow of paint toward the suction tube and preventing the flow of paint toward the handle.

12. A mechanism for reversing the flow of paint from a source of paint to a paint roller adapted for applying paint to a surface, the paint being pumped by a pump driven by an electric motor.

13. The mechanism of claim 12, wherein the mechanism is electronic.

14. The apparatus of claim 13, wherein the mechanism for reversing the direction of flow of paint comprises reversing the polarity of the motor.

15. The apparatus of claim 14, wherein the mechanism for reversing the polarity of the motor further comprises a bias switch normally biasing the polarity of the motor for forward rotation and a relay changing the switch bias thereby biasing the polarity of the motor for reverse rotation.

16. The apparatus of claim 15, further comprising a forward/reverse switch operating on the relay.

17. The apparatus of claim 16, wherein the forward/reverse switch acts on the relay through a transistor.

18. The apparatus of claim 12, wherein the mechanism for reversing the direction of flow of paint is mechanical.

19. The apparatus of claim 18, wherein the mechanism for reversing the direction of flow of paint further comprises a two-position valve having a first position permitting the flow of paint toward the handle and preventing the flow of paint toward the suction tube, and a second position permitting the flow of paint toward the suction tube and preventing the flow of paint toward the handle.

20. The apparatus of claim 12, wherein the pump is a peristaltic pump.
